(19) United States
(12) Patent Application Publication
(10) Pub. No.: US 2004/0143561 A1
(43) Pub. Date: Jul. 22, 2004

(54) Method for problem solving in technical systems with redundant components and computer system for performing the method

(76) Inventors: Finn Verner Jensen, Bronderslev (DK); Helge Langseth, Trondheim (NO)

Correspondence Address: HARNESS, DICKEY & PIERCE, P.L.C., P.O. BOX 8910, RESTON, VA, 20195, US

(21) Appl. No.: 10/702,517

(22) Filed: Nov. 7, 2003

(30) Foreign Application Priority Data
Nov. 14, 2002 (DK) PA200201752

(51) Int. Cl. G06F 17/00; G06N 5/02; G06F 15/18; G06G 7/00; G06N 3/02; G06E 3/00; G06E 1/00

(52) U.S. Cl. 706/46

(57) ABSTRACT

The invention pertains to a computer system for automated problem solving in technical systems with redundant components that via a user interface allows a skilled user to model the technical system and its components by using probabilities for causes, indications of redundant causes, probabilities that solutions repair causes, and the effects of questions on cause probabilities, and that via another user interface provides an end user with problem solving guidance by suggesting a sequence of questions and solutions, continually responded to by the user, until the failing system is repaired or all relevant solutions have been tried. The invention permits problem solving within industries where redundant components are often used to increase the safety of the system.

### FIELD OF THE INVENTION

The invention relates to a method for problem solving in technical systems with redundant components. The invention also relates to a computer system for performing the method. The computer system consists of a computer with installed software implementing the described methods.

### BACKGROUND OF THE INVENTION

Earlier computer systems of this type have only been useful for problem solving in failing systems with only a single error at a time. These earlier computer systems have had the underlying assumption that there can be only one error simultaneously, and have therefore not been used within areas where redundant components are used. A few earlier computer systems of this type have been able to handle redundant components, but these have not been able to model the problem solving sequence effeciently and flexibly.

The invention relates to a problem solving system that has been developed during the SACSO project, partially implemented in the BATS/Dezide tools, and forming the basis of patents U.S. Pat. Nos. 6,456,622, 6,535,865, and U.S. patent application Ser. Nos. 09/388,891, 09/644,117, and 09/866,411, filed by Hewlett-Packard, USA.

This is a problem solving system that carries out efficient problem solving in technical and non-technical domains. The purpose is to enable any user, independently of his or her level of skill, to solve complex problems without requiring professional assistance. Such systems are described in, e.g., the scientific papers [1-7].

The end-user is not expected to have any knowledge about or be interested in the diagnosis or cause of a problem. The end-user primarily wants to solve the problem, i.e. fix the failing system. A focus on identifying the cause, as described in [4-7] is not expected to be relevant. The problem solving will be concluded as soon as the problem has been solved.

### SUMMARY OF THE INVENTION

The invention describes methods to model a system with redundant components as a Bayesian network. In addition it describes methods for making calculations in this model, such that the optimal question or the optimal solution is suggested, based on the probabilities of the underlying causes, knowledge of which causes are redundant, probabilities that individual steps can help, as well as the cost of performing these steps.

These calculations are carried out by implementing one or more of the following steps and in the order as claimed in any of the claims of the present patent application or as described in any part of the description of the present patent application:

Permitting, by means of a first user interface, a skilled user to model the technical system and the redundant components by using one or more of the following parameters probabilities of causes, indications of redundant causes, probabilities of solutions for repairing the system, and the effect of questions on cause probabilities.

Giving, by means of a second user interface, an end-user problem solving guidance means by suggesting a sequence of questions and solutions, and where the means for guidance is performed as calculations including one or more of the following means:

(1) Representing on the second user interface to the end-user the technical system as a Bayesian network,

(2) Using minimum cutsets to model on the second user interface the redundant components of the technical system,

(3) Defining a probability that a solution solves the problem by defining a solution layer and a result layer, and by comparing what is modeled in the solution layer, and what is actually observed in the result layer.

(4) Discretely optimizing for sequencing of solutions by starting from an initial sequence and iteratively improving the sequence until the sequence converges to a local optimum.

(5) Using an observation-based efficiency to describe information received when a solution fails.

(6) Calculating the probability that a solution solves the problem by finding the probability of a minimal cut-set failing and the probability of a set of solutions failing in solving the problem, given a minimum cut-set is failing.

(7) Updating the probability of a minimal cutset, when new evidence is received, by expanding iteratively the evidence that a solution solves the problem.

(8) Updating the probability of a minimal cut-set, when answering a question, by defining questions for uncovering potential error symptoms, said updating being performed by calculating the effect on the distribution over the number of minimal cut-sets.

Using the described methods, the failed technical system will be corrected much faster and with much less chance of failure. The invention permits automated problem solving with industries where redundant components are often used, to improve the safety of the system. This holds particularly true in aerospace, nuclear powerplants, and the chemical process industry. These industries can now get a computer system that handles complex systems where errors can cause loss of human lives or have great economical consequences. To avoid these errors, redundant components are used, such that “single point of failure” components that upon failure can threaten the entire system are avoided.

The described methods and the computer system permit the user to do error correction and problem solving on this type of systems. The methods and the computer system is particularly suitable for systems with redundant components, both with regards the modeling of the components, and with regards the efficiency of the computer system in reaching a solution. The computer system will have a user interface that allows an expert to model the technical system and its components by using probabilities for causes, indication of redundant causes, probabilities that solutions help, as well as the effect of questions on cause probabilities, and another user interface that provides an end-user with assistance for problem solving by suggesting a sequence of questions and solutions.

In the following, the functionality of the present invention will be described based on problem solving for a technical product and with reference to the figures, where,

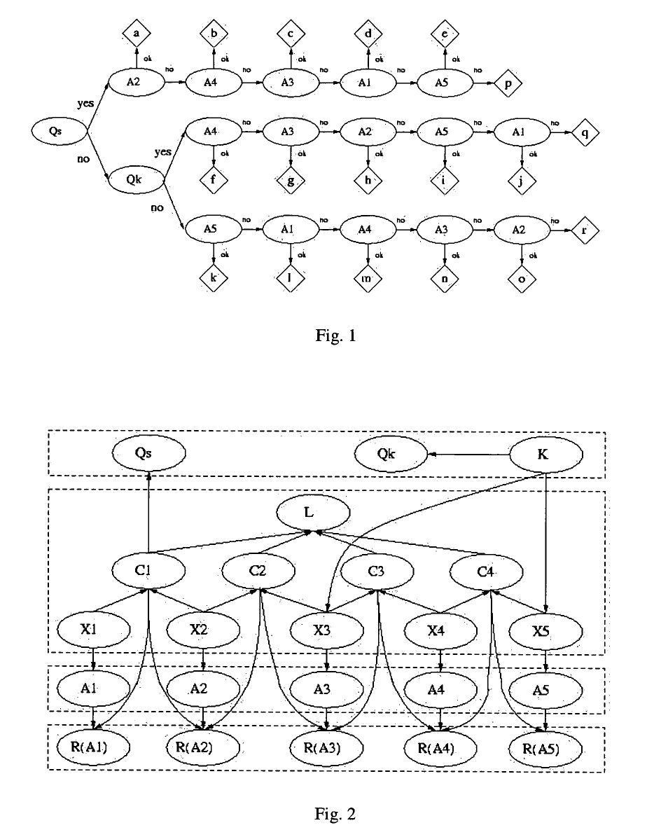

FIG. 1 shows a PL-strategy represented by a strategy tree.

FIG. 2 shows an example of a BN representation of a model.

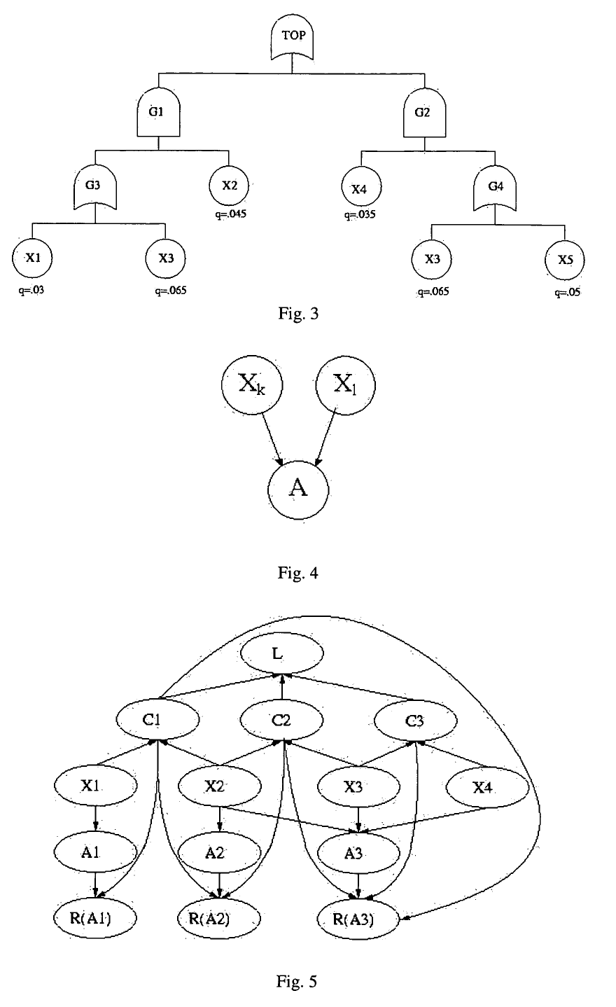

FIG. 3 shows an error tree that describes a basic problem solving model.

FIG. 4 shows an example of a solution A that can repair two components, Xₖ and Xₗ.

FIG. 5 shows an example of a model illustrating that an evidence does not affect a minimal cut-set (MCS), when we condition on failing minimal cut-sets (MCSs).

The basic new elements of this invention is that it extends the methods of prior art techniques to also handle systems with built-in redundancy, e.g., systems with multiple components offering the same functionality independently of each other.

One example of such a system is the automobile, where both the hand brake and the foot brakes provide the option of stopping the car. The two braking systems are totally independent of each other, such that the driver's ability to stop the car is not threatened, if one system breaks down, or the driver's arms or legs for some reason cannot be used.

Redundant systems are used in many domains with safety critical functions. If a system error can cause the loss of human life or have large economical consequences, it is generally not acceptable to have components that are not redundant and therefore may threaten overall system safety, if they fail.

If you have n components, that may each cause a system failure and each operate correctly with probability p, the overall system will fail with probability 1−pⁿ. If n is “high”, e.g., 100 (which is low, considering a nuclear power plant), even very reliable components (p=0.99) will pose problems. The probability of an overall system failure in this example is 0.63.

The industries where redundant systems are extremely important are: aerospace, nuclear power plants, and the chemical process industry. In addition redundant systems are important in many other industries such as: airlines, automobiles, trains, etc.

A cutset is a set of components, defined such that if all components in the cutset fails, it is certain that the system will also fail. In addition, a cutset only fails if all its members fail. A cutset is minimal, if it cannot be reduced without losing these properties.

If all components and the system itself are represented by binary (error=0/ok=1) variables, C₁, . . . , Cₖ as the minimal cutsets, and X₁, . . . , Xₙ as the components, the status of the system is given by:

φ(x)=1−Π_{j=1, . . . ,k}(1−Π_{i∈Ck}(1−Xᵢ))

Formally we can let the failing product consist of K components X={X₁, . . . , X_{K}}. Each component is either failing (Xᵢ=error) or OK (Xᵢ=ok). The product consists of R minimal cutsets (MCS's), and we use C={C₁, . . . , C_{R}) to represent the set of these. An MCS is failing (Cᵢ=error) if all its members are failing. Otherwise it is OK (Cᵢ=ok). The product is assumed to be failing, when the problem solving starts—and the problem solving ends, when/if the product is fully repaired.

We assume that only one MCS is in its failing state and use CF to represent the failing MCS. This assumption is standard for most problem solving-systems, and justified for systems that are used frequently and therefore tested often. Errors, where more subsystems fail simultaneously can easily be detected and handled separately.

The problem solving system (PL-system) can choose from a set of N possible solutions A={A₁, . . . , A_{N}}, that all have a chance of solving the problem. In addition there is a set of predefined questions Q={Q₁, . . . , Q_{M}} which can be posed. The purpose of the PL-system is to suggest a “good” PL-strategy.

A PL-strategy is a sequence of steps that either solve the problem or test all relevant steps. A PL-step is a step in a PL-strategy, either a solution or a question. For each PL-step Bᵢ, the user's cost (time, money, etc.) by carrying out the step is described with Kᵢ. The system is informed of the outcome of a PL-step, after it has been carried out.

Any PL-strategy can be represented by a strategy tree, see FIG. 1 for example. The inner nodes of this strategy tree (ovals) represent chance nodes—PL-steps that we do not know the outcome of. Any possible outcome of a chance node corresponds with a unique subtree of the strategy tree, which is found by selecting that way, named by that specific outcome. If, e.g., Qₛ=q, the strategy tree in FIG. 1 will suggest to carry out solution A₂—if Qₛ=┤q, it suggests that question Qₖ is asked. The terminating nodes (diamonds) indicate that the PL-strategy has ended, either because the problem is solved, or because all solutions has been tried out.

The “goodness” of a PL-strategy can be determined from its expected cost of repair (ECR). This indicates that the cost of a step should be balanced with the probability of the step helping to find the optimal PL-strategy. Breese and Heckerman [9] used Bayesian networks to model the problem solving domain. Jensen et al [10] describe extensions to this system.

The results from Jensen et al [10], and other related results within the problem solving domain has formed the basis of patents U.S. Pat. Nos. 6,456,622, and 6,535,865, and U.S. patent applications Ser. Nos. 09/388,891, 09/644,117, and 09/866,411, filed by Hewlett-Packard, USA.

In [9, 10] and the above mentioned patents and patent applications, the problem domain is limited to serial systems, i.e., systems where all cutsets consist of a single cause.

According to the present invention, the problem domain will be extended to any coherent system, where there can be multiple simultaneous error, but where these errors can be modeled using MCS's, such that at most one MCS may fail at any particular time.

Each year the industry uses millions on customer service, primarily for phone-based support or dispatch of onsite engineers. This has spawned the interest to develop automated problem solving systems, which can solve the users' problems without requiring assistance from support employees. In the SACSO project we worked with problem solving within printer systems consisting of both software (application, printer driver, network driver, etc.), hardware (PC, printer, network cards, etc.) and network elements. These printer systems are described further in [10, 11]. In Chapter 2 the basic model for the system and the formal terminology that are used to describe it are outlined. Chapter 3 describes how solutions are handled, and Chapter 4 describes how questions are handled. The calculation methods are described in more detail in Chapter 5.

2. The Problem Solving Model

In this chapter we will describe the problem solving model. We start by introducing Bayesian networks (BNs) which are used to represent the models. We then give a detailed description of how to generate the BN-representation of the problem domain.

2.1 Bayesian Networks

We represent the PL-domain with a Bayesian network [12, 13]. BNs have a long track record within reliability and safety sciences, from the early works [14, 15] to more recent results, see, e.g., [8-11, 16-21]. BNs give us a flexible language to describe the PL-model, and we use this to build a realistic model of the interactions, you can have with the failing product.

A Bayesian network is a compact representation of a multivariate probability distribution by using a graph G with directed arcs and no loops of arcs in the same direction, and a set of conditional probability distributions. The graph G consists of a set V of nodes in the graph, and a set E of edges (arcs) in the graph. We define the parent set of the node K, pa(K), as the set of nodes connected with K with an arc directed towards K. Each node K is described using a conditional probability distribution P(K|pa(K)). The full distribution over all variables in V can be calculated as P(V)=Π_{v∈V}P(V|pa(v)).

A basic property that may or may not be present between variables in a Bayesian network is conditional independence. If X, Y and Z are sets of variables, X and Y are conditionally independent given Z, if P(X|Y, Z=z)=P(X|Z=z). This is also written X⊥Y|Z.

From the printer domain, we have the following example of conditional independence. If the toner cartridge has run dry of toner fluid, this can be detected in at least two ways: (i) there can be an error message on the front panel, and (ii) the last page can be lighter than the first. There is a small probability that the error message does not show up and that the last page does not print lighter, even when the toner cartridge is nearly empty. If we determine that the last page is printed lighter, we can assume that this is because the toner cartridge is nearly empty, and this can then increase our belief that the error message will appear on the front panel. Therefore the two events are not independent. However—we if know that the toner cartridge is empty, the information about the error message on the front panel will not change our belief that the last page is printed lighter. The two events are thereby conditionally independent given knowledge of the toner cartridge's contents of toner fluid. Note in

FIG. 1 that the more complex models, where a solution can solve more than one component, easily can be defined.

2.2 The Basic Problem Solving Model

The failing product and the effect of the interaction from the user is modeled in a BN. As starting point we use a BN model of the product generated from the MCS representation (see [21] on this transformation). This part of the BN is denoted the system layer in FIG. 2. The system layer corresponds to the error tree in FIG. 3. Note that we have introduced a constraint node L, that enforces the assumption that only one MCS can be in its failing state. The MCS's are modeled using logical functions, such that Cᵢ=error, if and only if all components in the MCS are in their failing state. Therefore pa(Cᵢ) includes precisely those components that are members of the MCS Cᵢ, and P(Cᵢ|pa(Cᵢ)) is used to encode this deterministic relationship. After one propagation in the BN (see [22] for a description of this), the posterior probability of an error in a component given that the product fails, can be read from the node representing this component in the BN, and the probability that a certain MCS is the specific MCS causing the error can be read in the corresponding node. Then the system model is expanded with an explicit model for the effect of interactions between the product and the user. These interactions are limited to the predefined solutions A and questions Q. First we look at how solutions are modeled (see the solution layer in FIG. 2).

Solutions are connected with the system layer by making the children of the components, they can fix, i.e., pa(Aᵢ)⊂X. We describe the effect of an action A on all its components it can fix explicitly. This is done by extending the state space of A. For the state space we can use the notation +rX for the event where A solves X, and −rX when it does not. For example see FIG. 4, where solution A can fix components Xₖ and X₁. This implies that pa(A)={Xₖ, X₁}, and the state space of A is sp(A)={+rXₖ+rX₁, +rXₖ−rX₁, −rXₖ+rX₁, −rXₖ−rX₁}. Without referring to sp(A), we use the notation {A^{↓X}=ja} for the event where A fixes X, and {A^{↓X}=no} when it does not. Thus, in this example {A^{↓Xk}=yes} refers to the event {A=+rXₖ+rX₁νA=+rXₖ−rX₁}.

We make a number of assumptions about the PL-domain. Some are made to simplify the model definition, and others are beneficial when calculations in the BN are performed:

We ignore errors introduced by the user in connection with the problem solving process.

A solution can only fix components in its parental set, i.e., P(A^{↓X}=yes|X=error)=0, when X∉pa(A).

The state of a component X₁ does not affect the user's ability to fix Xₖ.

It does not affect our belief in a user's ability to carry out solutions correctly when we receive information that he has failed carried out a solution. This also means that we assume that the group of possible users is homogenous, such that most of these typically have the same skills and abilities.

A solution cannot fix a component which is already working, i.e., P(A^{↓X}=ja|X=ok)=0.

These assumptions are sufficient to make the PL-system operational, and to make the calculation algorithms of Chapter 5 work. For simplicity we also assume that A^{↓Xk}⊥ A^{↓Xk}|{Xₖ, X₁} when k≠1. This means that a conditional probability P(A|pa(A)) is fully specified by the set of probabilities {P(A^{↓Xk}=yes|Xₖ=error): Xₖ∈pa(A)}. This situation is often described as “independence of causal influence” [23] or independence between causal effects. It implies that if A can fix t components, it is sufficient to define t conditional probabilities to describe P(A|pa(A)).

There is a significant difference between what is modeled in the solution layer, and what is actually observed. The solution layer describes the events {A^{↓X}=yes|X=error}, but we can also observe whether the product is fixed or not, i.e., if the event {A^{↓X}=yes AΛX∈C_{F}} occurs. To work with observations as evidence, we extend the model with a result layer, which consists of a set of nodes R(A), one for each A∈A. R(A), the result of A, is defined as R(A)=ok if A^{↓X}=yes for some X∈C_{F}, and R(A)=no otherwise.

The probability that a solution A fixes the product, P(R(A)=ok), is a natural extension of Vesely and Fussell's measure for component importance [24], when A can only fix one component X. Let I^{VF}(X) denote the probability that X is critical, i.e., X∈C_{F}, given that the product is defect. Thus:

$$\begin{matrix}P ( R ( A ) = ok ) = P ( X ∈ {C}_{F} ) \times P ( {A}^{↓ X} = yes \vert X = error ) \\ = {I}^{VF} ( X ) \times P ( {A}^{↓ X} = yes \vert X = error ) .\end{matrix} \qquad ( 1 )$$

When A can fix a set of components, we have:

$$\begin{matrix}P ( R ( A ) = ok ) = P ( {⋁}_{X ∈ X} \{ {A}^{↓ X} = yes ⋀ X ∈ {C}_{F} \} ) \\ = {\sum }_{C1 ∈ C} {I}^{VF} ( {C}_{1} ) {\prod }_{X ∈ C1 ⋂ pa ( A )} P ( {A}^{↓ X} = yes \vert X = error ) ,\end{matrix}$$

where I^{VF}(C₁) is the probability that all components in C₁ are, i.e., I^{VF}(C₁) is equal to the probability that C₁ is the failing cutset.

With respect to questions, we distinguish between symptom questions and configuration questions. Symptom questions are used to examine potential manifestations of errors—an example from the printer domain is “Does the printer's test page look OK?”. This question is designed to help shed some light on the error at the cutset level, e.g., by trying to reproduce the product error in another situation. (If the test page prints correctly, the error is most likely related to the application that generates the print job). Symptom questions are connected to the MCS nodes in the domain, see the node Q_{S} in FIG. 2. The arcs are pointing in the causal direction, i.e., from the MCS nodes to the questions. The parent set of a symptom question Q_{S}, pa(Q_{S})⊂C, defines the set of MCS's, that directly influence the probability that this symptom appears.

Configuration questions are used to uncover the configuration of the product and its environment. An example from the printer domain could be: “which operating system are you using?”. Configuration questions are not directly related to a specific MCS, but can affect the probability that different components fail. The arcs connecting configuration questions with the system layer are therefore directed from the configuration question node towards the components, see K in FIG. 2. Since the user not always reply correctly to a configuration question, we have modeled the response as a stochastic variable, see Q_{K} in FIG. 2. Thus we will receive information about Q_{K} (and not K directly) when the model is used, and Q_{K} is therefore necessary in the model together with K.

2.3 Building PL-models

[25] describes a tool for fast building of PL-models. This tool is further described in the related patent U.S. Pat. No. 09/388,891. PL-models produced by this tool are simpler than the PL-models described in this invention, since all MCS's only include a single component, i.e., only one component can fail at one time.

3. Sequences of Solutions

In this chapter we examine the situation where the only possible PL-steps are solutions. In this situation the PL-strategy is a simple PL-sequence, i.e., a sequence of solutions are carried out after each other until the product is repaired. Let e denote evidence collected until now in the PL-process, i.e., a set of solutions which failed in fixing the product. To be more specific we use eⱼ to denote the evidence that the first j solutions in the sequence S=<A₁, . . . , A_{N}> have all failed, eⱼ={R(Aᵢ)=no: i=1, . . . ,j}. If Aₖ solves the problem with full certainty, P(eₖ)=0, i.e., the PL-sequence is terminated after the k'th step. Note that e₀={Ø} and P(e₀)=1, since the product is assumed to be defect when starting the PL-session.

The expected cost of repair (ECR) of a PL-sequence S=<A₁, . . . , Aₙ>, where solution Aᵢ has a cost Cᵢ, is the average cost until a solution has solved the problem or all solutions have been tested:

ECR(S)=Σ_{i=1, . . . ,N}Cᵢ×P(eᵢ₋₁). (2)

A PL-sequence is optimal if it achieves the minimal ECR of all PL-sequences.

3.1 The Greedy Approach.

The idea to use I^{VF}( ) to sort the solutions generalizes to our situation, see Equation (1), and we can therefore define a solution's efficiency as follows:

ef(A|e)=P(R(A)=ok|e)/C_{A}.

The greedy approach for selection of the step sequence is defined as follows:

Algorithm 1 (The Greedy Approach).

(1) For all Aᵢ∈A, calculate ef(Aⱼ|e₀);

(2) Let S be the list of solutions sorted after ef(Aᵢ|e₀);

(3) Return S.

The greedy approach does not always return the optimal sequence. One counter example is shown below:

Example: Consider the domain of FIG. 2 (with error data from FIG. 3). We assume perfect repair solutions, Cᵢ=1 for all solutions, and ignore the questions Q_{S} og Qₖ. The greedy approach chooses the sequence <A₃, A₂, A₄> with ECR=1.58. The optimal sequence can be found by an exhaustive search: <A₂, A₄> with ECR=1.47.

An immediate improvement of Algorithm 1 is to recalculate the efficiencies each time new evidence is obtained. In this manner we ensure that all information available when the i'th step is calculated, is taken into consideration. Note that we use Bⱼ to denote the j'th step in the strategy S:

Algorithm 2 (The Greedy Approach with Recalculation).

(1) e←{Ø}; A′←{A₁, . . . , A_{N}}; S=<>;

(2) Fori=1 to N

a. For all Aⱼ∈A′, calculate ef(Aⱼ|e);

b. Select Aₖ∈A′ such that ef(Aₖ|e) is maximised;

c. Bᵢ←Aₖ; A′←A′\{Aₖ}; e←e∪{R(Aₖ)=nej}.

(3) Return S;

If we use this algorithm in the above example, we get the sequence <A₃, A₄, A₂> with ECR=1.53. This is better than the greedy approach, but still not optimal.

3.2 Dependent Solutions

In general we can have a situation where different solutions can repair the same components, and similarly that different components can be repaired by the same solution. These solutions are called dependent solutions.

A domain where the cost of a solution is not dependent of the sequence of earlier solutions is said to have dependent solutions, where there exist solutions Aᵢ, Aⱼ og Aₖ such that:

ef(Aᵢ|Ø)/ef(Aⱼ|Ø)≠ef(Aᵢ|R(Aₖ)=no)/ef(Aⱼ|R(Aₖ)=no)

A domain has dependent solutions if there exists two solutions Aᵢ and Aⱼ such that pa(Aᵢ)∩pa(Aⱼ)≠Ø or there exists two solutions Aᵢ and Aⱼ, two components Xₖ∈ pa(Aᵢ) and X₁∈pa(Aⱼ) and an MCS Cₘ such that {Xₖ, X₁}⊂Cₘ. An example from the printer domain is the pair of solutions “Remove the toner cartridge and reinsert it correctly” and “Try with another toner cartridge”, since these can both solve problems where the toner cartridge is incorrectly inserted.

Vesely and Fussell's component importance is in general not optimal when the domain has dependent solutions. To optimize a suboptimal strategy, we use a modified version of an algorithm for combinatorial optimization (see, e.g., [7]). This algorithm starts from an initial sequence and improves this sequence iteratively until it converges to a local optimum. Note that B⁽ⁱ⁾ₖ (step 2a) denotes the k'th PL-step in the solution sequence S, when the i'th iteration is begun. Also note that this algorithm has converged (step 3) when the ECR of the found sequence is not lower than ECR of an earlier found sequence.

Algorithm 3 (Discrete Optimization).

(1) Initialization: S←<B₁, . . . , B_{N}> for a sequence of solutions in A;

(2) For i=1 to N

a. For j=i to N

i. Rⱼ←<B⁽ⁱ⁾₁, . . . , B⁽ⁱ⁾ᵢ₋₁, B⁽ⁱ⁾ⱼ, B⁽ⁱ⁾ᵢ, . . . , B⁽ⁱ⁾ⱼ_31 1, B⁽ⁱ⁾ⱼ₊₁, . . . , B⁽ⁱ⁾_{N}>;

b. Select j₀∈[i . . . N] such that ECR(Rⱼ₀) is minimized;

c. S←Rⱼ₀;

(3) If not converged, then go to 2;

(4) Return S;

A sequence S=<A₁, A₂, . . . , Aᵢ, . . . , Aⱼ, . . . , A_{N}> is a local optimum if we have ECR(S)≦ECR(S′) when we insert Aⱼ before Aᵢ(j>i) in S to obtain S′=<A₁, A₂, . . . , Aᵢ₋₁, Aⱼ, Aᵢ, . . . , Aⱼ₋₁, Aⱼ₊₁, . . . , A_{N}>. It is clear that Algorithm 3 converges to a local minimum, when ECR(S) is guaranteed non-increasing after each run of the algorithm (the algorithm can decide not to make any changes by selecting j₀ such that Rⱼ₀=S in step 2b). It is however not guaranteed that the algorithm converged towards the globally optimal sequence. The most important step of Algorithm 3 is the initialization of S in step 1. To ensure rapid convergence to a near-optimal sequence, it is beneficial to select a sequence close to the optimal. A natural choice is to initialize S with a sequence found by Algorithm 2. It is however easy to see that this sequence is a local optimum in itself, and it will therefore not be able to improve it with Algorithm 3. Instead we suggest that the solution sequence is initialized by sorting based on the observation-based efficiency (obef). We describe this below.

Consider a situation where the evidence e has been collected and it has been decided that the next solution to be tried is A. To calculate the observation-based efficiency, the PL-system must calculate the information that can be obtained about the failing product by informing it that A does not solve the problem—and even more importantly—the value of this information. It is natural to quantify this value as the difference in ECR between two models: (i) the PL-system where the collected evidence is e′={e, R(A=no)}, and (ii) the PL-system where A has been removed but the collected evidence is e″=e. Assume that the sequence of remaining solutions when the evidence is e′, is S(e′), and that the sequence of remaining solutions, when the evidence is e″ and A is unavailable, is S(e″). We then define the conditional ECR of the sequence S=<A₁, . . . , A_{N}> given e′ as ECR(S|/e′)=Σ_{j=1, . . . ,N}Cⱼ×P(eⱼ₋₁|e′). Finally we define the value of the information from the observation that R(A)=no, given the current evidence e as:

VOI(R(A)=no|e)=ECR(S(e′)|e′)|e′)−ECR(S(e″)|e′),

e.g., VOI(R(A)=no|e) is the difference between the expected cost of strategies S(e′) and S(e″). Note that both expected costs are calculated conditional on e′, the evidence already collected when the two strategies are considered.

To sum up we want to find the value of the information a failing solution can provide when we look for an optimal sequence. The value is calculated as VOI(R(A)=no|e), and we receive this extra information with the probability P(R(A)=no|e). If we consider this value as a refund, it is natural to consider the “true” cost of solution A as:

C_{A}=C_{A}−P(R(A)=no|e)×VOI(R(A)=no|e).

C_{A} is the cost we “use” to carry out A; C_{A}−C_{A} is the expected reduction in ECR of the remaining sequence of solutions that is obtained when learning that A fails. In the earlier mentioned patents it is assume that VOI(R(A)=no|e)=0. On the other side, if C_{A} is used as A's cost in the calculation of efficiency, it will change the PL-strategy to take the information actually received into consideration. This leads to the definition of the observation-based efficiency:

Definition. The observation-based Efficiency.

$$obef ( A \vert e ) = \frac{P ( R ( A ) = ok \vert e )}{{C}_{A} - P ( R ( A ) = no \vert e ) \times VOI ( R ( A ) = no \vert e )}$$

An algorithm using the observation-based efficiency does in general not obtain an optimal sequence. This is however of less importance since we only use the sequence as input to Algorithm 3 and does not consider it a final solution in itself.

One problem with the above definition is that VOI(R(A)=no|e) only can be calculated if the optimal sequence for all remaining solutions (after carrying out A) can be determined to calculate ECR(S(e′)|e′) and ECR(S(e″)|e′)—computationally a daunting task. Two approximations are mentioned in [26]—one based on the Shannon entropy of efficiencies of the remaining solutions, and one computationally simpler method based on using the myopic sequence of solutions.

Table 1 shows results from a simulation. Three PL-models have been used: the example model from FIG. 3 (with N=5 solutions and R=4 cutsets), the CPQRA model [28] (N=25, R=20), and Norstrøm et al's example [7] (N=6, R=4). For each model, the costs of solutions and probabilities of causes are set randomly. In addition, the probability that a solution repairs a component has been set randomly in the interval [0.9, 1.0]. Algorithm 2 and 3 were run¹ and compared with respect to ECR. The simulations were carried out 500 times. The numbers shown indicate the relative number of times Algorithm 2 found a result that was worse than the one found by Algorithm 3 (Rel. num.), the average relative difference in ECR in these runs (Avg. rel. diff.), and the maximal relative difference in ECR (Max. rel. diff.):

Rel.num. Avg.rel.diff. Max.rel.diff. ¹Alogorithm 3 was initialized with a sequence where the observation-based was used to sort the solutions. The value of information was approximated with the myopic strategy.

TABLE 1

| | Rel. num. | Avg. rel. diff. | Max. rel. diff. |
|---|---|---|---|
| Example model in FIG. 3 | 8.2% | 4.0% | 7.5% |
| CPQRA model [28] | 9.4% | 4.2% | 8.2% |
| Norstrøm et al.'s | 4.0% | 4.9% | 9.2% |
| example [7] | | | |

The results in Table 1 show that even for the relatively small models, we have examined, a strategy generated with Algorithm 2 fails relatively often, and the extra cost by following an inferior strategy can be considerable.

Since it is NP-hard to find the optimal sequence, Algorithm 3 also fails occasionally. This occurred for instance in the CPQRA model, where Algorithm 3 was even worse than Algorithm 2 in 1.2% of the simulations with the maximum relative difference in cost at 2.1%.

4. Questions

When we add questions to our PL-model, the strategy is represented by a strategy tree, see FIG. 1. Note that ECR cannot be calculated with Equation 2 in this situation, instead we use a recursive calculation method to calculate the expected cost of repair.

Let S be a PL-strategy, starting with a step B₍₁₎ and then continuing with a strategy conditioned on the different outcomes of B₍₁₎. Then ECR of S can be calculated recursively as:

ECR(S)=C₍₁₎+Σ_{b(1)∈sp(B(1))}P(B₍₁₎=b₍₁₎)×ECR(S|B₍₁₎=b₍₁₎), (3)

where C₍₁₎ is the cost of step B₍₁₎ and ECR(S|B₍₁₎=b₍₁₎ is the ECR of the sub-tree S, when it follows the branch, where B₍₁₎=b₍₁₎. Recursion is terminated when ECR(Ø|.)=ECR(.|R(Aⱼ)=ok)=0.

The obvious way to determine whether it pays to pose a question Q, is to calculate the value of information from the specific question. Let the strategy be defined as <Q, S>, where S is the optimal strategy conditional on the answer to Q, and let S′ be the optimal strategy, when Q cannot be suggested. We define VOI(Q) as:

VOI(Q)=ECR(S′)−Σ_{q∈sp(Q)}P(Q=q)×ECR(S|Q=q).

The system shall then suggest the question, if VOI(Q)>C_{Q}.

5. Calculation Methods

In this chapter we will describe methods to carry out the necessary calculations in the model. When the PL-system interacts continually with the user, it is important that calculations can be carried out “real-time”. It is important to identify time intervals where the system is awaiting answer from the user, and use these time intervals to carry out calculations.

Before the system is started, it carries out an initialization where the following probabilities are calculated: (i) probabilities that each component is defect given that the product fails, (ii) probabilities that solutions are succesful, and (iii) initial probabilities for answers to different questions.

In the following, we will focus on how to incorporate information from the performed PL-steps in the system, i.e., how to update the probability distributions when the collected evidence e is extended.

5.1 Solution Sequences

First we look at PL-systems that only consist of solutions, and describe a method for calculation of P(R(A)=ok|e) for a solution A, where e is evidence not involving A. Then we describe a method to calculate P(e) (necessary for the ECR-calculations, see Equation 2). Note that the evidence e can only contain a list of failed solutions, i.e., e={R(A)=no: A∈A′}. If a solution is successful, the PL-session ends, and there is no need to incorporate the evidence in the system.

An important element in the calculations is conditional independence. Let nd(V) be the non-descendants of V in a graph G with directed edges, Y∈nd(X) if and only if there is no path X→ . . . →Y in G. An important result that we will use often is that V⊥nd(V)|pa(V) for any variable V∈V.

The foundation of our calculation method is that if we know that Cᵢ is the failing cutset, it is easy to calculate the probabilities of success given e. It appears that P(R(A)=ok|Cᵢ=error, e)=P(R(A)=ok|Cᵢ=error), see the proof below. Since the failing cutset is not known during the problem solution, we use:

$$\begin{matrix}P ( R ( A ) = ok \vert e ) = {\sum }_{C1 ∈ C} P ( R ( A ) = ok \vert {C}_{1} = error , e ) \times \\ P ( {C}_{1} = error \vert e ) \\ = {\sum }_{C1 ∈ C} P ( R ( A ) = ok \vert {C}_{1} = error ) \times \\ P ( {C}_{1} = error \vert e )\end{matrix}$$

to calculate P(R(A)=ok|e). Then we prove the above claim:

Claim. Let A∈A be a solution, and let the evidence gathered during problem solving be e, e={R(Aᵢ)=no: Aⱼ∈A′} (A∉A′). Assume that the user's ability to repair a component X is not dependent of the state of other components, A^{↓X}⊥X′|X for all X′∈X\{X}, and that information that the user fails to carry out a solution does not influence our belief in his ability to carry out other solutions, A^{↓Xk}ᵢ⊥A^{↓Xl}ⱼ|{Xₖ, X₁} when i≠j. Then P(R(A)|Cₘ=error, e)=P(R(A)|Cₘ=error). Therefore the evidence e does not affect R(A), when we condition on the failing MCS.

Proof. First, note that if P(R)=ok|Cₘ=error)=0, no evidence can change this probability. Therefore we have that P(R(A)|Cₘ=error, e)=P(R(A)|Cₘ=error), if A cannot repair any components in Cₘ. Assume then that A can repair components in only one MCS, C₁. If C₁=error, then all components Xⱼ∈C₁ will be in their failing state. Therefore we have evidence on the set pa(A), and since e only contains non-descendants of A, we have A⊥e| {C₁=error}. Therefore we also have that R(A)⊥e |{C₁=error}, and therefore that P(R(A)|C₁=error, e)=P(R(A)|C₁=error).

In the general situation A can repair more than one MCS. To prove that the above claim also holds in this situation, we introduce a stochastic variable ζ(C₁), which is defined such that ζ(C₁)=yes if {Xᵢ=error: Xᵢ∈C₁ΛXⱼ=ok: Xⱼ∉C₁}; ζ(C₁)=no otherwise. Note that the effect from conditioning on ζ(C₁)=yes is that all X∈X are given evidence, and the set pa(A)⊂X is instantiated. Therefore P(R(A)=ok|ζ(C₁)=yes, e)=P(R(A)=ok|ζ(C₁)=yes). Since A^{↓X}⊥X′|X for all X′∈X\{X}, we have that P(R(A)|C₁=error, e)=P(R(A)|ζ(C₁)=yes, e). Finally it follows that P(R(A)|C₁=error, e)=P(R(A)|C₁=error).

We use the above equation to calculate the probability that a solution A repairs the product:

P(R(A)|e)=Σ_{Cl∈C}P(R(A)|C₁=error)×P(C₁=error|e). (6)

Thus, calculating P(R(A)|e) can be done by finding P(R(A)|C₁=error) and P(C₁=error|e) for all C₁∈C. The values of P(R(A)|C₁=error) can easily be calculated before problem solving starts, but P(C₁=error|e) must be calculated in the specific situation.

We now show that the above equation also can be used to calculate P(C₁=error|eᵢ) quite efficiently; recall that eᵢ is the evidence where the first i solutions of the sequence S=<A₁, . . . , A_{N}> have failed. We first use Bayes' rule to examine how this probability should be updated when new evidence {R(Aᵢ)=nej} is received and added to the existing evidence eᵢ₋₁:

$$\begin{matrix}P ( {C}_{1} = error \vert {e}_{i} ) = P ( {C}_{1} = error \vert {e}_{i - 1} , R ( {A}_{i} ) = no ) \\ = \frac{\begin{matrix}P ( R ( {A}_{i} ) = no \vert {C}_{1} = error , {e}_{i - 1} ) \times \\ P ( {C}_{1} = error \vert {e}_{i - 1} )\end{matrix}}{P ( R ( {A}_{i} ) = no \vert {e}_{i - 1} )} \\ = \frac{\begin{matrix}P ( R ( {A}_{i} ) = no \vert {C}_{1} = error ) \times \\ P ( {C}_{1} = error \vert {e}_{i - 1} )\end{matrix}}{P ( R ( {A}_{i} ) = no \vert {e}_{i - 1} )}\end{matrix} \qquad ( 7 )$$

P(R(Aᵢ)=no|eᵢ₋₁) is just a normalization constant in this calculation which can be found with:

P(R(Aᵢ)=no|eᵢ₋₁)=Σ_{Ck∈C}P(R(Aᵢ)=no|Cₖ=error)×P(Cₖ=error|eᵢ₋₁).

Therefore P(C₁=error|eᵢ) can be calculated by expanding the evidence iteratively. The first step in this procedure requires as input the prior probability distribution over the MCS's, P(C₁=error|e₀). This distribution must be calculated with a full propagation in the Bayesian network, see [22], note that this calculation can be performed offline before problem solving begins. The evidence eᵢ is then incorporated by using Equation (7) until we achieve P(C₁=error|eᵢ). Thus the calculation of P(R(A)|eᵢ) has the complexity O(R) where R is the number of MCS's in the domain if we have stored the value of P(C₁=error|eᵢ₋₁). As a consequence the total complexity of Algorithm 1 will be O(NR+Nlog(N)), and the complexity of Algorithm 2 will be O(N(NR+N))=O(N²R).

Then we examine how to calculate P(eᵢ)—a number that is required for the ECR calculations, see Equation 2. This can be done by using the identity P(eᵢ)=P(R(Aᵢ)=no|eᵢ₋₁)P(eᵢ₋₁) and carry out the calculation iteratively—P(R(Aᵢ)=no|eᵢ₋₁) is obtained from Equation 6, and P(e₀)=1 per definition. The calculation of P(eᵢ) therefore has complexity O(R) if we store the values P(eᵢ₋₁). In total the calculation of ECR will therefore have time complexity O(NR).

The time complexity to generate a full solution sequence based on the observation-based efficiency is dominated by the demanding calculations to find VOI(.|e). If this value is approximated by calculating ECR of the sequence generated by Algorithm 2, the time complexity of generating a complete solution sequence with the observation-based efficiency is O(N³R). If one is satisfied with the more “crude” approximation from Algorithm 1, the time complexity can be reduced to O(N²(log(N)+R)).

The time complexity of Algorithm 3 is given by the complexity of the initialization and the cost of O(N²) calculations of ECR. Thus the total complexity of Algorithm 3, when initializing from the obef sequence is O(N³R). This should be compared with similar calculations in an error tree, reported to O(N²3^{N}) in [7].

5.2 Questions

In this section we describe the calculation methods when the PL-model is extended with questions.

5.2.1 Symptom Questions

Symptom questions are used to uncover potential error symptoms. They are connected to the system layer on the MCS level with edges directed from components to questions, see Q_{S} in FIG. 2. The parent set of a symptom question Q_{S} in our BN representation is therefore limited to the MCS nodes, pa(Q_{S})⊂C. In addition, symptom questions have no descendants in the graph. It follows that Q_{S}⊥V\{C, Q_{S}}|C. Thus to calculate the effect of a symptom question on the strategy, it is only necessary to calculate the effect on the distribution over the MCS's, P(C₁=error|Q_{S}=q, e). This can be done by using Bayes' rule:

$$\begin{matrix}P ( {C}_{1} = error \vert {Q}_{s} = q , e ) = \frac{\begin{matrix}P ( {Q}_{s} = q \vert {C}_{1} = error , e ) \times \\ P ( {C}_{1} = error \vert e )\end{matrix}}{P ( {Q}_{s} = q \vert e )} \\ = \frac{\begin{matrix}P ( {Q}_{s} = q \vert {C}_{1} = error ) \times \\ P ( {C}_{1} = error \vert e )\end{matrix}}{P ( {Q}_{s} = q \vert e )}\end{matrix} \qquad ( 8 )$$

where P(Q_{S}=q|e)=Σ_{Ck∈C}P(Q_{S}=q|Cₖ=error)×P(Cₖ=error|e). Thus the complexity of calculating P(C₁=error|Q_{S}=q, e) from P(C₁=error|e) is O(R). If we assume that the sequence of solutions required to calculate the ECR values of Equation 5 is based on Algorithm 2, then a question can be evaluated in time complexity O(N²R). Note that this will require calculations of ECR for multiple solution sequences (described in Section 5.1)—one for each possible answer to the question.

Note that Q_{S}⊥V\{C, Q_{S}}|C indicates that symptom questions do not corrupt the calculations of R(A|e) in Equation 6—therefore we can use this calculation method to calculation R(A|e), even when evidence e contains answers to other symptom questions.

5.2.2 Configuration Questions

Configuration questions are designed to uncover information about the product environment. Configuration nodes are connected to the system layer via the component layer with edges that are directed from questions towards components, see K in FIG. 2. The answer to the question is modeled as a stochastic variable dependent on the configuration, see Q_{K} in FIG. 2.

Similar to symptom questions we want to evaluate Q_{K} after Equation 5. First we note that R(A)⊥e|{C₁=error} also when configuration questions have been asked, {Q_{K}=q}⊂e. Recall that P(R(A)|e′, C₁=error)=P(R(A)|C₁=error), when e′ is a list of solutions (not containing A) that have failed. This result can trivially be extended to situations where e contains answers to questions, since configuration questions are non-descendants of solutions' result nodes. We can therefore calculate the efficiency of a solution with Equation 6 also in situations where configuration nodes have been answered. Similarly we can calculate the ECR values required to evaluate a configuration question Q_{K} (after Equation 5) efficiently by incorporating the effect of a question Q_{K} on the cutset nodes by using Equation 8.

Special attention is necessary in the situation where a configuration question Q_{K1} is evaluated, and the evidence e already contains the answer to another configuration question Q_{K2} together with a list of failed solutions e′, e={Q_{K2}=q, e′}. The answers to the two configuration questions Q_{K1} and Q_{K2} are not independent given the actual cutset—since we have P(Q_{K1}=q|e, C₁=error)=P(Q_{K1}=q|Q_{K2}=q, C₁=error). Therefore we must take all answers to earlier configuration questions into consideration when we want to calculate P(Q_{K1}=q|e). One consequence of this conditional dependence is that the fast methods for incorporating new evidence in the system, see Equations 7 and 8, cannot be generalized to evidence containing answers to configuration questions, if the distributions of other configuration questions should be updated correctly. We therefore have to carry out a propagation in the model as soon as a configuration question has been answered. The complexity of evaluating a configuration question is therefore O(N²R). The time complexity for incorporating the answer in the system is exponential in the number of components.

Examples of Employment of the Invention:

1) A server, with software installed to help solve problems, can be accessed via a web browser. Both employees and customers can then be helped to solve their problems via the browser, faster and more precisely.

2) A portable computer, mobile phone or PDA has software installed to do automated problem solving, and can be used by en engineer with responsibility for troubleshooting in a complex system.

3) A portable computer with the automated troubleshooting system, that are used for faster problem solving within the aerospace industry.

4) A portable computer with the automated troubleshooting system, that are used for faster problem solving within the nuclear power industry.

5) A portable computer with the automated troubleshooting system, that are used for faster problem solving within the chemical process industry.

### References

[1] W. E. Vesely, Fault tree handbook, Tech. Rep. NUREG-0492, US Nuclear Regulatory Committee, Washington D.C. (1981).

[2] Q. Zhang, Q. Mei, A sequence of diagnosis and repair for a 2-state repairable system, IEEE Transactions on Reliability R-36 (1) (1987) 32-33.

[3] J. Kalagnanam, M. Henrion, A comparison of decision analysis and expert rules for sequential analysis, in: Uncertainty in Artificial Intelligence 4, North-Holland, N.Y., 1990, pp. 271-281.

[4] W. Xiaozhong, Fault tree diagnosis based on Shannon entropy, Reliability Engineering and System Safety 34 (1991) 143-167.

[5] W. Xiaozhong, R. M. Cooke, Optimal inspection sequence in fault diagnosis, Reliability Engineering and System Safety 37 (1992) 207-210.

[6] R. Reinertsen, W. Xiaozhong, General inspection strategy for fault diagnosis—minimizing the inspection costs, Reliability Engineering and System Safety 48 (3) (1995) 191-197.

[7] J. Norstrom, R. M. Cooke, T. J. Bedford, Value of information based inspection-strategy of a fault-tree, in: Proceedings of the tenth European Conference on Safety and Reliability, 1999, pp. 621-626.

[8] S. Srinivas, A polynomial algorithm for computing the optimal repair strategy in a system with independent component failures, in: Proceedings of the Eleventh Annual Conference on Uncertainty in Artificial Intelligence, San Fransisco, Calif., 1995, pp. 515-522.

[9] J. S. Breese, D. Heckerman, Decision-theoretic troubleshooting: A framework for repair and experiment, in: Proceedings of the Twelfth Conference on Uncertainty in Artificial Intelligence, Morgan Kauffmann Publishers, San Fransisco, Calif., 1996, pp. 124-132.

[10] F. V. Jensen, U. Kjaerulff, B. Kristiansen, H. Langseth, C. Skaanning, J. Vomlel, M. Vomlelova, The SACSO methodology for troubleshooting complex systems, Artificial Intelligence for Engineering, Design, Analysis and Manufacturing 15 (5) (2001) 321-333.

[11] C. Skaanning, F. V. Jensen, U. Kjaerulff, P. Pelletier, L. Rostrup-Jensen, Printing system diagnosis: A Bayesian network application, Workshop on Principles of Diagnosis, Cape Cod, Mass. (2000).

[12] J. Pearl, Probabilistic reasoning in intelligent systems: networks of plausible inference, Morgan Kauffmann Publishers, San Mateo, Calif., 1988.

[13] F. V. Jensen, Bayesian networks and decision graphs, Springer Verlag, N.Y., 2001.

[14] R. E. Barlow, Using influence diagrams, in: C. A. Clarotti, D. V. Lindley (Eds.), Accelerated life testing and experts' opinions in reliability, 1988, pp. 145-157.

[15] H. J. Call, W. A. Miller, A comparison of approaches and implementations for automating decision analysis, Reliability Engineering and System Safety 30 (1990) 115-162.

[16] J. G. Torres-Toledano, L. E. Sucar, Bayesian networks for reliability analysis of complex systems, Lecture notes in Artificial Intelligence 1484 (1998) 195-206.

[17] N. Fenton, B. Littlewood, M. Neil, L. Strigini, A. Sutcliffe, D. Wright, Assessing dependability of safety critical systems using diverse evidence, IEE Proceedings Software Engineering 145 (1) 35-39.

[18] N. E. Fenton, M. Neal, Bayesian belief nets: A causal model for predicting defect rates and resource requirements, Software Testing and Quality Engineering 2 (1) (2000) 48-53.

[19] G. Dahll, B. A. Gran, The use of Bayesian belief nets in safety assessment of software based systems, International Journal of General Systems 29 (2) (2000) 205-229.

[20] P. H. Ibarguengoytia, L. E. Sucar, E. Morales, A probabilistic model approach for fault diagnosis, in: Eleventh International Workshop on Principles of Diagnosis, 2000. pp. 79-86.

[21] A. Bobbio, L. Portinale, M. Minichino, E. Ciancamerla, Improving the analysis of dependable systems by mapping fault trees into Bayesian networks, Reliability Engineering and System Safety 71 (3) (2001) 249-260.

[22] F. V. Jensen, S. L. Lauritzen, K. G. Olesen, Bayesian updating in causal probabilistic networks by local computations, Computational Statistics Quarterly 4 (1990) 269-282.

[23] D. Heckerman, J. S. Breese, A new look at causal independence, in: Proceedings of the Tenth Annual Conference on Uncertainty in Artificial Intelligence, Morgan Kauffmann Publishers, San Fransisco, Calif., 1994, pp. 286-292.

[24] W. E. Vesely, A time-dependent methodology for fault tree evaluation, Nuclear Engineering and design 13 (1970) 339-360.

[25] C. Skaanning, A knowledge acquisition tool for Bayesian-network troubleshooters, in: Uncertainty in Artificial Intelligence: Proceedings of the Sixteenth Conference, Morgan Kauffmann Publishers, San Fransisco, Calif., 2000, pp. 549-557.

[26] H. Langseth, F. V. Jensen, Heuristics for two extensions of basic troubleshooting, in: Seventh Scandinavian Conference on Artificial Intelligence, SCAI'01, Frontiers in Artificial Intelligence and Applications, IOS Press, Odense, Denmark, 2001, pp. 80-89.

[27] M. Sochorova, J. Vomlel, Troubleshooting: NP-hardness and solution methods, in: The Proceedings of the Fifth Workshop on Uncertainty Processing, WUPES'2000, Jindrichuv Hradec, Czech Republic, 2000, pp. 198-212.

[28] Center for Chemical Process Safety, Guidelines for Chemical Process Quantitative Risk Analysis, American Institute of Chemical Engineers, New York, 1989.

[29] J. Vomlel, On quality of BATS Troubleshooter and other approximative methods, Technical Report, Department of Computer Science, Aalborg University, Denmark (2000).

1. A method for problem solving in a technical system with one or more redundant components, said method comprising the steps of:
permitting, by means of a first user interface, a skilled user to model the technical system and the redundant components by using one or more of the following parameters:
probabilities of causes, indications of redundant causes, probabilities of solutions for repairing the system, and the effect of questions on cause probabilities.

2. A method according to claim 1, said method comprising the steps of:
giving, by means of a second user interface, an end-user problem solving guidance means by suggesting a sequence of questions and solutions, and where the means for guidance is performed as calculations including the following means:
representing on the second user interface to the end-user the technical system as a Bayesian network,
using minimum cutsets to model on the second user interface the redundant components of the technical system,
defining a probability that a solution solves the problem by defining a solution layer and a result layer, and by comparing what is modeled in the solution layer, and what is actually observed in the result layer.

3. A method according to claim 2, said method further comprising the step of:
discretely optimizing for sequencing of solutions by starting from an initial sequence and iteratively improving the sequence until the sequence converges to a local optimum.

4. A method according to claim 3, said method further comprising the step of:
using an observation-based efficiency to describe information received when a solution fails by calculating the probability that a solution solves the problem by finding the probability of a minimal cut-set failing and the probability of a set of solutions failing in solving the problem, given a minimum cut-set is failing.

5. A method according to claim 4, said method further comprising the step of:
updating the probability of a minimal cutset, when new evidence is received, by expanding iteratively the evidence of solutions not solving the problem.

6. A method according to claim 5, said method further comprising the step of:
updating the probability of a minimal cut-set, when answering a question, by defining questions for uncovering potential error symptoms, said updating being performed by calculating the effect on the distribution over the number of minimal cut-sets.

7. A method for problem solving in a technical system with one or more redundant components, said method comprising the steps of:
permitting, by means of a first user interface, a skilled user to model the technical system and the redundants components by using one or more of the following parameters:
probabilities of causes, indications of redundant causes, probabilities of solutions for repairing the system, and the effect of questions on cause probabilities,
giving, by means of a second user interface, an end-user problem solving guidance means by suggesting a sequence of questions and solutions, and where the means for guidance is performed as calculations including the following means:
representing on the second user interface to the end-user the technical system as a Bayesian network,
using minimum cutsets to model on the second user interface theredundant components of the technical system,
defining a probability that a solution solves the problem by defining a solution layer and a result layer, and by comparing what is modeled in the solution layer, and what is actually observed in the result layer,
calculating the probability that a solution solves the problem by finding the probability of a minimal cut-set failing and the probability of a set of solutions failing in solving the problem, given a minimum cut-set is failing, and
updating the probability of a minimal cutset, when new evidence is received, by expanding iteratively the evidence of solutions not solving the problem.

8. A method for problem solving in a technical system with one or more redundant components, said method comprising the steps of
permitting, by means of a first user interface, a skilled user to model the technical system and the redundant components by using one or more of the following parameters:
probabilities of causes, indications of redundant causes, probabilities that solutions repair the system, and the effect of questions on cause probabilities,
giving, by means of a second user interface, an end-user problem solving guidance means by suggesting a sequence of questions and solutions, and where the means for guidance is performed as calculations including the following means:
representing on the second user interface to the end-user the technical system as a Bayesian network, and
using minimum cutsets to model on the second user interface the redundant components of the technical system.

9. A method for problem solving in a technical system with one or more redundant components, said method comprising the steps of:
permitting, by means of a first user interface, a skilled user to model the technical system and the redundant components by using one or more of the following parameters:
probabilities of causes, indications of redundant causes, probabilities that solutions repair the system, and the effect of questions on cause probabilities,
giving, by means of a second user interface, an end-user problem solving guidance means by suggesting a sequence of questions and solutions, and where the means for guidance is performed as calculations including the following means:
representing on the second user interface to the end user the technical system as a Bayesian network, and
using minimum cutsets to model on the second user interface the redundant components of the technical system.

10. A method for problem solving in a technical system with one or more redundant components, said method comprising the steps of:
permitting, by means of a first user interface, an end-user problem solving guidance means by suggesting a sequence of questions and solutions, and where the means for guidance is performed as calculations including the following means:
representing on the second uder interface to the end-user the technical system as a Bayesian network
using minimum cutsets to model on the second user interface the redundant components of the technical system,
defining a probability that a solution solves the problem by defining a solution layer and a result layer, and by comparing what is modeled in the solution layer, and what is actually observed in the result layer,
calculating the probability that a solution solves the problem by finding the probability of a minimal cut-set failing and the probability of a set of solutions failing in solving the problem, given a minimum cut-set is failing, and
updating the probability of a minimal cutset, when new evidence is received, by expanding iteratively the evidence of solutions not solving the problem.

11. A computer system for performing the method according to claim 1, said computer system comprising:
a first user interface being capable of permitting a skilled user to model on the first user interface a technical system and redundant components of the technical system,
a second user interface being capable of representing, on the second user interface to an end user, the technical system as a Bayesian network, and
said second user interface furthermore being capable of modelling, on the second user interface to the end-user, the redundant components of the technical system.
